(19) United States
(12) Patent Application Publication
(10) Pub. No.: US 2006/0280874 A1
(43) Pub. Date: Dec. 14, 2006

(54) Use of thermal spraying with niobium oxides and niobium alloys during the production process of rolled steel plates

(75) Inventors: Luiz Roberto Martins Miranda, Rio de Janeiro (BR); Ladimir Jose Carvalho, Rio De Janeiro (BR); Antonio Carlos Goncalves Pereira, Rio de Janeiro (BR)

Correspondence Address: Fildes & Outland, 20916 Mack Avenue, Suite 2, Grosse Pointe Woods, MI, 48236, US

(73) Assignee: Coppe/Ufrj Coordenacao dos Programas de Pos Graduacao de Engenharia da Universidade, Rio de Janeiro (BR)

(21) Appl. No.: 10/552,933

(22) PCT Filed: Aug. 18, 2003
(86) PCT No.: PCT/BR03/00117

§ 371 Date: Oct. 11, 2005

(30) Foreign Application Priority Data
Apr. 28, 2003 (BR) PI301126-7

(51) Int. Cl. B05D 1/08; C23C 4/00

(52) U.S. Cl. 427/446

(57) ABSTRACT

This innovation describes the utilization of the Thermal Spraying with Niobium oxides and alloys in the manufacturing of rolled steel plates, to be applied in the production of thermal exchange equipment, or those that are exposed to atmospheres with corrosive gases in high temperature, as for example, H₂S and CO₂, as well as fumes from solvents and acids.

### TECHNICAL FIELD

This innovation refers to the use of niobium oxides and niobium alloys applied by the Thermal Spraying technique during the production of rolled steel plates manufactured by the pre-coated conventional process, on the train of rolls. As a result, flat, conformed or profiled steel plates could be industrially produced in large scale, already protected against highly corrosive environments, mainly in those presenting high temperatures, showing presence of gases such as H₂S, SO₂, CO₂ as well as fumes or acids.

### BACKGROUND OF THE INVENTION

In the utilization of rolled plates in corrosive environments, it is common the use of Enamel as a anticorrosive coating. Notwithstanding, several problems take place during the assemblage of equipment as for example, heat exchangers and heat recuperators among others, since the Enamel does not have sufficient mechanical resistance to the rolling and eventual curving that the steel plates might have to endure.

Consequently, the coating looses adherence and exposes the steel to the corrosive environment, reducing the useful life of the rolled steel plates.

### SUMMARY OF THE INVENTION

In its most general aspect, this invention proposes the use of Thermal Spraying with niobium oxides, niobium alloys and associations thereof with other metals, alloys or oxides as an anticorrosive coating, in the industrial production of plain or coated rolled plates, according to the application for the Brazilian Patent PI 0203534-0.

### DETAILED DESCRIPTION OF THE INVENTION

The Brazilian Patent PI N.0203534-0 for this invention refers more particularly to the utilization of Thermal Spraying with niobium oxides and niobium alloys such as Al—Nb, Ni—Nb, among others, preferably the niobium oxides, during the manufacturing of plain or coated rolled steel plates. The steel plates production process and the niobium application obey traditional processes as the described below:

1—Degreasing of the plate right out from the rolling;

2—Blasting of the superior and inferior plate surfaces at SA 2½ degree;

3—Thermal Spraying by oxi-acetylene torch on both superior and inferior surfaces of the steel plate with niobium-based oxides and alloys;

4—Separation of the plates, by cutting, in the desirable dimensions on the rolling train;

5—Storage of the coated rolled steel plates;

6—Eventual shaping of the plates, by bending, profiling or any other specific demand from the consumer;

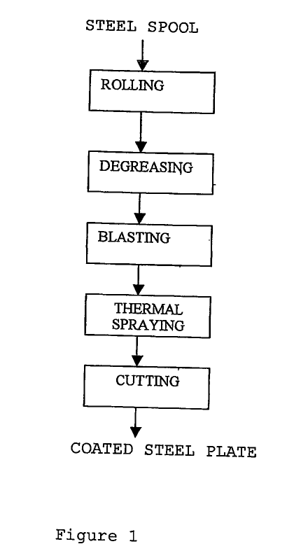

FIG. 1 represents, in block diagram, a conventional manufacturing process for rolled steel plates.

Among the advantages of the Thermal Spraying application in the production line of rolled steel plates are the improvement of the adherence providing plate conformations for bending, profiling or any other shaping without the exposition of the substrate to the corrosive environment, as well as the improvement of the superficial state, preparing it to receive the finishing coat of paint.

1. “Use of Thermal Spraying with Niobium oxides and Niobium alloys During the Production Process of Rolled Steel Plates.” Characterized by applying Niobium, its oxides and alloys such as Ni—Nb, Al—Nb, among others, in the production of coated steel plates.
